(19) United States
(12) Patent Application Publication
(10) Pub. No.: US 2010/0074379 A1
(43) Pub. Date: Mar. 25, 2010

(54) Tuning replica generation methods and apparatus for their most optimum performance in processing transient signals

(76) Inventor: Ming-Chiang Li, Mitchellville, MD (US)

Correspondence Address: Ming-Chiang Li, 11415 Bayard Drive, Mitchellville, MD, 20721, US

(21) Appl. No.: 12/382,834

(22) Filed: Mar. 25, 2009

Related U.S. Application Data
(60) Provisional application No. 61/041,514, filed on Apr. 1, 2008.

(51) Int. Cl. H04L 27/06

(52) U.S. Cl. 375/343

(57) ABSTRACT

The embodiments of the present invention are most optimum methods and apparatus for processing transient (pulsed, non-cooperative, non-reproducible, complex, or simultaneous) signals; in particular, for their unbeatable vigor in passive source identifications; for their ultra precision transient spatial range and Doppler measurements; for their supreme powers in rejection noise and interference contamination; for their utmost abilities in deciphering random, chaotic, turbulent, explosive, thermo nuclear, and other countless transient phenomena. In particular, an embodiment of the present invention is an apparatus for processing transient signals that uses replica generations and which comprises: (a) a signal receiving apparatus which receives one or more signals having transient in nature, at least one of them cannot be repeatedly produced or is a signal of opportunity, and the signals have pulse lengths ranging from less than tenth of a picosecond to higher than several microseconds, and frequency widths from less than 0.10 MHz to higher than 40 GHz; (b) a tuning apparatus which accepts signals from the receiving apparatus as inputs, tunes one or more of these signals in response to a requirement of interest, where the requirement of interest includes, but not limited to, shortening or elongating the one or more of signals; (c) a replica generation apparatus, which accepts signals from the tuning apparatus as inputs, and outputs a train of replica pairs, where relative separations between two members in the replica pairs are same or different; (d) an integration apparatus which performs correlation integrations that is to correlate between two members in the replica pairs and to convert the train of replica pairs into a baseband signal.

### TECHNICAL FIELD OF INVENTION

The present invention relates to tune replica generation methods and apparatus for their most optimum performance in processing transient signals, in particular, for their unbeatable vigor in passive source identifications; for their ultra precision transient spatial range and Doppler measurements; for their supreme powers in rejecting noise and interference contamination; for their utmost abilities in deciphering random, chaotic, turbulent, explosive, thermo nuclear, and other countless transient phenomena.

### BACKGROUND OF INVENTION

When radar was invented, it was a general belief that the optimum radar receiver is a true correlation receiver. However, due to the technical difficulties, such a receiver could not be constructed experimentally. Instead super heterodyne receivers had to be used to receive radar signals. A fundamental step in super heterodyne receiving is the down conversion which first converts radar signals from radio frequency (RF) to intermediate frequency (IF). The down conversion only retains a small portion of the information contained in the radar signals and wipes out majority of them. These causes the severe problems as they exist today, such as range inaccuracy, Doppler range ambiguity, fratricides, excessive clutter contamination, undue inter system interference, etc. These deficiencies led to well publicized tragedies for example, in 1994, two US fighter jets shot down two US Army helicopters and killed 26 people over northern Iraq; a United States Navy battleship in the Persian Gulf shot down an Iranian passenger plane on Jul. 3, 1998; Patriot missiles shot down a British Tornado fighter on Mar. 23, 2003; and again a US Nay F/A-18 on Apr. 2, 2003 during Operation Iraqi Freedom. These deficiencies led to Federal Aviation Administration's (FAA) decision to abandon the radar for future air traffic control. FAA is currently developing a nationwide automatic dependent surveillance broadcast network (ADS-B) to replace the current radar network for air traffic control despite ADS-B vulnerability.

As the technology evolves, we can have a true correlation receiver based on optical fiber recirculation loops. The true correlation receiver has been referred to as an interferoceiver and was disclosed in the patent application “Robust and Broadband Signal Processing using Replica Generation Apparatus”, application Ser. No. 11/231,841.

Interferoceiver is an ultra broadband radar receiver, which is able to cover the spectrum of entire microwave band. It can freeze a fast moving target to reveal the micro Doppler signatures for passive identification. The ability of interferoceiver in capturing various transient signals with individual single pulses reduces, numbers of radar transmissions, which in turn suppress excessive clutter contamination, and undue inter system interference. The use of interferoceiver would assure the success of a ship in self defense and of fratricide elimination in ballistic missile defense.

Interferoceiver is capable of investigating transient and noncooperative RF signals over a wide range of frequencies and to identify their characteristics. It is an important and indispensable tool in intelligence gathering of electronic warfare to defeat hostile military operations. This is to say that interferoceiver leads to a revolution in radar and electronic warfare technologies.

Transient phenomena are abundant in nature, such as random and chaotic media, turbulence and turbulent flows, chemical and nuclear explosions, vibrations and instabilities, thunder and shock waves, etc. But it was difficult to decipher their intrinsic and characteristic features. The invention of strobe light showed us new possibilities. An interesting photo was taken by Harold Edgerton in 1964 of a bullet piercing through an apple with the aid of a strobe light, which led to the high-speed photography with the camera shutter speed of less than one microsecond. Interesting features on the apple blast and bullet travel became clearly recorded. The high-speed photography captures the intrinsic features on a transient phenomenon of apple blasting, and the positions of apple fragments at the instant of strobe light flashing.

High-speed photography freezes motions of transient phenomena and records instantaneous positions of their constituencies and fragments, but lacks the ability in revealing their instantaneous velocities. All classical motions are governed by the second law of Newton, which is a second order of differential equation. To predict how a transient phenomenon will evolve with time, a prerequisite is to have complete information on the instantaneous initial positions and velocities of its constituencies and fragments. Hence high-speed photography alone cannot provide all necessary information to understand transient phenomena. Without instantaneous initial velocities, the time evolutions of transient phenomena could not be precisely predicted or controlled. It would not be possible to intercept hostile ballistic missiles successfullys, to predict hurricanes accurately, to control thermo nuclear reactions, etc. But help is on the way. Interferoceiver is capable of revealing the instantaneous initial velocities. Our understanding toward transient phenomena will dramatically increase, that would lead to precisely predictions of their time evolutions and to well define mechanisms of controlling them.

Despite the excellence of various forms of interferoceiver as described in application Ser. No. 11/231,841, we move forward to push them for most optimum performance in processing transient signals, in particular, for their unbeatable vigor in passive source identifications; for their ultra precision transient spatial range and Doppler measurements; for their supreme powers in rejecting noise and interference contamination; for their utmost abilities in deciphering, random, chaotic, turbulent, explosive, thermo nuclear, and other countless transient phenomena.

### TEACHING OF INVENTION

The teaching of the present invention is arising from following papers: Ming-Chiang Li, “Applications of Interferoceiver for Battleship Self Defense”, Proc. SPIE 6566, 65660E, 1-10 (2007); Ming-Chiang Li, “The Use of Optical RF Network for Target Detection and Tracking”, Proc. SPIE 6567, 656711, 1-11 (2007); and Ming-Chiang Li, “The Use of Interferoceiver for the Prevention of Fratricide in Missile Defense”, Proc. of SPIE 6968, 69681K, 1-12 (2008). The above three papers are incorporated by reference herein.

We found interesting applications of interferoceiver as well as encountered several problems during the research activities as documented in above three papers. One of the problems is the precision on tracking the location of a target. Safety is the utmost goal in air travel. Air traffic controller has to detect and track every plane in flight precisely. As more and more planes take to the air every year, accuracy in detecting their locations will become extremely demanding. The air traffic control systems in existence are based on the current radar technology and cannot meet future needs. FAA has decided that the future control systems should be satellite based navigation systems. However, such systems are vulnerable, especially in view of terrorist attack and natural disturbances as discussed in separated letters to editor by Jose J. Monroy and Ming-Chiang Li in Avionic Magazine (Nov. 1, 2007).

The imprecision of target tracking by the current radar systems are due to their super heterodyne receivers. The length of radar pulses from air traffic control systems is usually long. As the sky is packed with planes, a received radar pulse may be simultaneously reflected by a number of planes. Then, the imprecision will be multiplied.

The second problem is the precise target velocity to foresee where the target will be. This is particularly important in missile defense. Velocity is a very important physical parameter in predicting where and when a hostile missile will be for interception; more accurate measurements of instantaneous velocities lead to more accurate prediction in the location and the instant of interception. Velocity accuracy is directly related to the length of radar pulse, longer the pulse more accurate the velocity. However, there are physical limits for transmitters to transmit long and powerful radar pulses. Furthermore, a longer pulse will cause the received radar pulse simultaneously reflected by the hostile missile and its decoys. As a result of simultaneous multiple reflections, the tracking precision will degrade.

Both of the instantaneous location and velocity of the hostile missile have to be very precisely measured in order to predict accurately the location and instant of its interception. A shorter pulse leads to a precise instantaneous location, but less reliable instantaneous velocity. On other hand, a longer pulse leads to a precise instantaneous velocity, but a less precise instantaneous location. These are the fundamental problems in the measurements of both instantaneous location and velocity.

The same fundamental problems also appear in measurements of all random, chaotic, turbulent, explosive, thermo nuclear, and other countless transient phenomena. For instance, velocity varies at every spatial location in a turbulent medium. To understand the turbulent medium fully, experiments have to obtain extra high spatial and velocity precisions. But the measured velocity by electromagnetic or laser pulses is the summed average of velocity distribution. A longer pulse offers better velocity and poor spatial precisions. A shorter pulse is just the vice versa.

The situations are the same in passive identification of signal sources, especially when their signals are simultaneously received. For instance, this is the main objective for a channelizer to resolve simultaneous signals for electronic intelligence gathering. A longer time interval of receiving leads to better frequency precision and more interference among these simultaneous signals. On other hands, a shorter time interval is just the opposite with poor frequency precision and less interference.

In light of the above, there is a need in the art for replica generation methods and apparatus that can overcome the above identified problems.

### SUMMARY OF THE INVENTION

The embodiments of the present invention are methods and apparatus that solve the above identified problems in the art and provide most optimum methods and apparatus for processing transient (pulsed, non-cooperative, non-reproducible, complex, or simultaneous) signals; in particular, for their unbeatable vigor in passive source identifications; for their ultra precision transient spatial range and Doppler measurements; for their supreme powers in rejection noise and interference contamination; for their utmost abilities in deciphering random, chaotic, turbulent, explosive, thermo nuclear, and other countless transient phenomena.

In particular, an embodiment of the present invention is an apparatus for processing transient signals that uses replica generations and which comprises: (a) a signal receiving apparatus which receives one or more signals having transient in nature, at least one of them cannot be repeatedly produced or is a signal of opportunity, and the signals have pulse lengths ranging from less than tenth of a picosecond to higher than several microseconds, and frequency widths from less than 0.10 MHz to higher than 40 GHz; (b) a tuning apparatus which accepts signals from the receiving apparatus as inputs, tunes one or more of these signals in response to a requirement of interest, where the requirement of interest includes, but not limited to, shortening or elongating the one or more of signals; (c) a replica generation apparatus, which accepts signals from the tuning apparatus as inputs, and outputs a train of replica pairs, where relative separations between two members in the replica pairs are same or different; (d) an integration apparatus which performs correlation integrations that is to correlate between two members in the replica pairs and to convert the received signals by the signal receiving apparatus into a baseband signal. As those of ordinary skill in the art would appreciate that the present apparatus does not rely on super heterodyne and deficiencies of super heterodyne receivers do not appear in the art of the present invention.

In another embodiment of the present invention, the invented apparatus wherein further comprises: (e) a tracing apparatus which traces path lengths of signal paths from signal sources through the signal receiving apparatus, tuning apparatus, and replica generation apparatus to the integration apparatus, and evaluates path length differences of two members in replica pairs, wherein the tracing apparatus might further trace signal emission times from the signal sources; (f) an analysis/display apparatus which accepts inputs from the integration apparatus and tracing apparatus, and produces information of interest.

In another further embodiment of the present information, the invented apparatus wherein further comprises: (e) a DC filter which accepts inputs from the integration apparatus and removes a direct current from the inputs; (f) a Fourier processor accepts inputs from the DC filter, Fourier analyzes the inputs, and produces information of interest.

### BRIEF DESCRIPTION OF THE FIGURE

A complete understanding of the present invention may be gained by considering the following detailed description in connection with the accompanying drawings in which:

FIG. 1 shows a block diagram of an apparatus that is fabricated in accordance with the present invention.

FIG. 11 shows block diagrams of tuning apparatus for fabrication in accordance with the present invention.

FIG. 12 shows a block diagram of a gating device for fabrication in accordance with the present invention.

FIG. 13 shows a block diagram of a stretching device for fabrication in accordance with the present invention.

FIG. 14 shows another block diagram of a stretching device for fabrication in accordance with the present invention.

FIG. 2 shows a block diagram of an apparatus along with a Fourier process that is fabricated in accordance with the present invention.

FIG. 21 shows a block diagram of an apparatus along with an integration apparatus, DC filer, and Fourier process that is fabricated in accordance with the present invention.

FIG. 3 shows a block diagram of an apparatus along with sources of interest, a tracing apparatus, and an analysis/display apparatus that is fabricated in accordance with the present invention.

FIG. 31 shows a block diagram of an apparatus along an integration apparatus, DC filter, and an analysis/display apparatus that is fabricated in accordance with the present invention.

Components which are the same in the previous figures have been designated by the same numerals for ease of understanding

### DETAILED DESCRIPTION

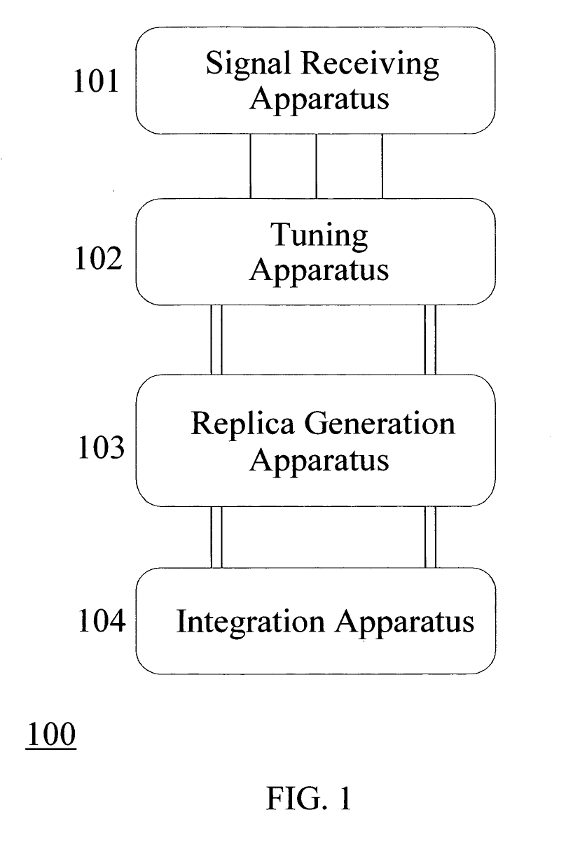

FIG. 1 shows an embodiment of apparatus 100 for processing transient, pulsed, non-cooperative, non-reproducible, complex, or simultaneous signals in accordance with the present invention. As shown in FIG. 1, apparatus 100 includes signal receiving apparatus 101, which receives one or more transient (pulsed, non-cooperative, non-reproducible, complex, or simultaneous) signals for investigation, and outputs the received signals to tuning apparatus 102, which tunes one or more of these signals by modifying or manipulating them in response to required spatial and Doppler precisions. The tuning apparatus 102 outputs tuned and untuned signals. Replica generation apparatus 103 takes the signals from the tuning apparatus 102 as input and produces a train of replica pairs, where relative separations between two members in the replica pairs are same or different. After receiving inputs, integration apparatus 104 performs Doppler, self, or mutual (cross) correlation operations on the replica pairs at RF or optical level, and converts the received signals by the signal receiving apparatus into baseband signals.

The embodiment of FIG. 1 denotes a general description of the present invention, in particular, for their unbeatable vigor in passive source identifications; for their ultra accurate transient spatial range and Doppler measurements; for their supreme powers in rejecting noise and interference contamination; for their utmost abilities in deciphering random, chaotic, turbulent, explosive, thermo nuclear, and other countless transient phenomena.

The signal receiving, apparatus 101, replica generation apparatus 103, and integration apparatus 104 are shown in the patent application “Robust and Broadband Signal Processing using Replica Generation Apparatus”, application Ser. No. 11/231,841. The specification of the above application is incorporated by reference herein. Thus, whenever the terms of signal receiving apparatus, replica generation apparatus, and integration apparatus are used herein, they are meant to be used in their most general and inclusive sense.

FIG. 2 shows, in pictorial forms, another embodiment 200 of apparatus 100 which further comprises: Fourier Processor 105, which analyzes outputs from integration apparatus 104 and determines Doppler shifts, frequencies, pulse widths, component distributions, interferences, or other intrinsic features. Fourier processor 105 is shown in the patent application “Robust and Broadband Signal Processing using Replica Generation Apparatus”, application Ser. No. 11/231,841. The specification of the above application, as was mentioned above, is incorporated by reference herein. Thus, whenever the term of Fourier processor is used herein, it is meant to be used in its most general and inclusive sense.

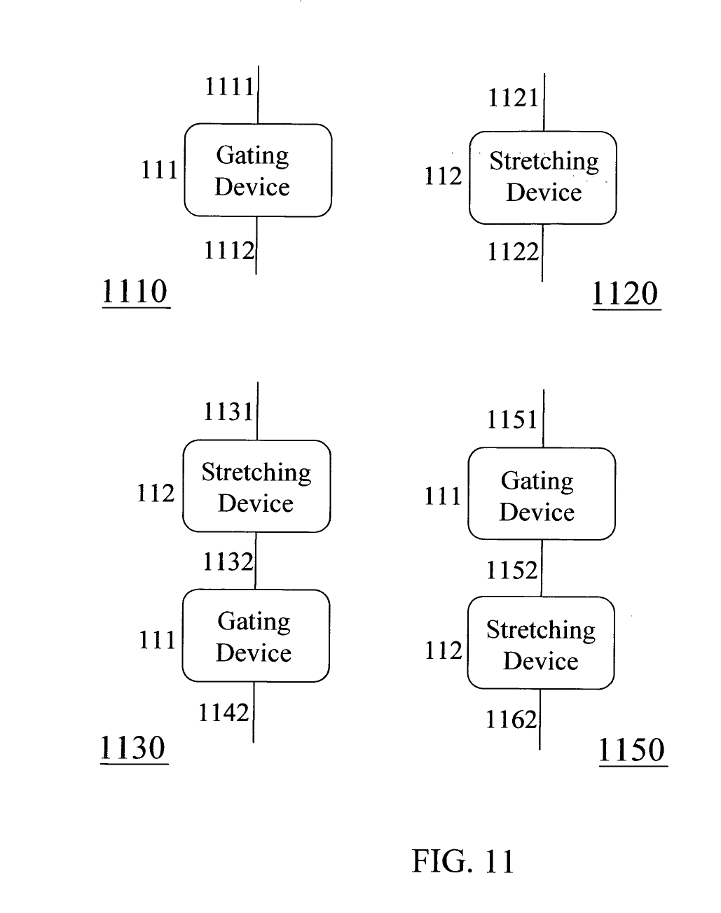

FIG. 11 shows, in pictorial forms, tuning apparatus 102 for use in fabricating embodiments of present invention in modifying or manipulating input signals. When some input signals need not be modified or manipulated, tuning apparatus 102 directly outputs these signals to replica generation apparatus 103. The detailed descriptions of tuning apparatus 102 are specified below.

The invented apparatus 100 is a high precision apparatus. As shown in embodiment 1110 of FIG. 11, tuning apparatus 102 takes signals from signal receiving apparatus 101 through signal path 1111, and inputs it to gating device 111. Like all other high precision, it needs a front end apparatus to specify functions, which invented apparatus 100 has to perform. As those of ordinary skill in the art would appreciate that the front end apparatus varies and depends on the specific functions. For instance in radar application, the front end apparatus might be a conventional super heterodyne based surveillance radar system with or without an aid of an apparatus as described in the patent application “Robust and Broadband Signal Processing using Replica Generation Apparatus”, application Ser. No. 11/231,841. The front device is known to those of ordinary skill in the art by following the present teaching. Thus whenever the term of front device is used herein, it is meant to be used in its most general and inclusive sense.

A front end apparatus, according to the requirement on spatial precision, specifies which portion and size of the signals from signal path 1111 have to be selected, or which have to be rejected. Gating device 111 uses the specified portion and size as a guide in selecting a part of the signals from signal path 1111, and outputs the selected part through signal path 1112 to replica generation apparatus 103.

Gating device 111 can be RF or optical and is known to those of ordinary skill in the art. The gating operation deduces the signal strength. If necessary, the reduced signal strength can be overcome by appropriate amplification, then it is understood that a signal amplifier may be inserted into either one of signal paths 1111 and 1112, or signal amplifiers inserted into both paths 1111 and 1112 to amplify the signal in signal path 1112. Gating device can be RF or optical, and will be described later. Many ways of fabricating appropriate amplifiers are known to those of ordinary skill in the art by following the present teaching. Thus, whenever the term of amplifier is used herein, it is meant to be used in its most general and inclusive sense.

Signal paths 1111, 1112, or others that are free air, coaxial cables, wave guides, micro strips, optical RF link systems, or . . . along with various amplifiers, antennas, lenses, connectors, terminals, ports, converters . . . . Many different ways of fabricating appropriate signal paths are well known to those of ordinary skill in the art. Furthermore, various signal paths are shown in the patent application “Robust and Broadband Signal Processing using Replica Generation Apparatus”, application Ser. No. 11/231,841. The specification of the above application, as was mentioned above, is incorporated by reference herein. Thus, whenever the term signal path is used herein, it is meant to be in a most general and inclusive sense.

As those of ordinary skill in the art would appreciate, the location of a target in conventional radar measurements is provided by range determination based on the round trip time delay of a radar pulse to and from the target. The imprecision on range is from the imprecision measurement on the leading or trailing edges of a radar pulse. If a leading edge is rising very sharply, then the time on the leading edge is well defined and the error is small. Conventional radar receivers are super heterodyne receivers. Radar signals have to be down converted to IF for processing. It is the IF band width, which limits the rising time. Furthermore noises can blur the leading edge. A similar argument is also held for trailing edges. As those of ordinary skill in the art would appreciate, gating would not lead to ultra precision range determinations for super heterodyne based radar systems.

The theory of accurate range determination is documented in the published paper, “The Use of Optical RF Network for Target Detection and Tracking”, Proc. SPIE 6567, 656711, 1-11 (2007). The paper is incorporated by reference herein. As described in the paper, the spatial range is determined through the maximum of correlation between the transmitted and reflected radar pulses. Thus, it opens the door for the accurate range determination. However when the radar pulse is from multiple reflections, the range accuracy will suffer. Then invented apparatus 100 with the aid of one or more gating devices is able to restore the accuracy.

The fratricides, which Patriot missiles shot down a British Tornado fighter on Mar. 23, 2003 and again a US Nay F/A-18 on Apr. 2, 2003 during Operation Iraqi Freedom, are due to difficulties in differentiating the speed of jet fighters from that of hostile ballistic missiles. If the radar systems of Patriot missiles are able to differentiate the differences of their speeds, the fratricides would not have happened. For purpose of illustration, consider a simple scenario. Assuming, a jet fighter with speed 300 m/sec and a hostile ballistic missile with speed 1200 m/sec are at 100 km away from a Patriot missile site, whose radar system has a frequency of 5 GHz. Then the Doppler shift for the jet fighter is 10,000 Hz and for the ballistic missile is 40,000 Hz. The Patriot missile radar has to have a pulse repetition rate of 40,000 Hz in order to avoid the Doppler ambiguity. At such a repetition rate, the corresponding alias free range is 3750 m. Then one has to wait for more than 27 transmissions after the first transmitted pulse, and before the first reflected pulse from the ballistic missile could return to the Patriot missile radar site for processing. With such delay, it is difficult to differentiate the speed of jet fighters from that of hostile ballistic missiles. As discussed in the paper “The Use of Interferoceiver for the Prevention of Fratricide in Missile Defense”, Proc. of SPIE 6968, 69681K, 1-12 (2008), Patriot radar systems do not routinely measure velocities in differentiating jet fighters from hostile ballistic missiles.

A reflected radar signal carries rich information on the RF signature of rotating compressor and turbine blades for jet engines. The rich information is currently referred to as micro Doppler signatures. It has been recognized quite early that these signatures could be used for the purpose of passive identification for differentiating one type of aircraft from another. Hostile ballistic missiles do not have these signatures. If Patriot radar systems have the capabilities of measuring micro Doppler signatures, the fratricide would not have happened. However, super heterodyne based Patriot radar receiver cannot to do so.

The invented apparatus as disclosed in the patent application “Robust and Broadband Signal Processing using Replica Generation Apparatus”, application Ser. No. 11/231,841 is able to measure Doppler velocities and micro Doppler signatures with a single radar pulse. Then the fratricides can be avoided. A detailed discussion on fratricide avoidance can be found in these three papers: Ming-Chiang Li, “Applications of Interferoceiver for Battleship Self Defense”, Proc. SPIE 6566, 65660E, 1-10 (2007); Ming-Chiang. Li, “The Use of Optical RF Network for Target Detection and Tracking”, Proc. SPIE 6567, 656711, 1-11 (2007); and Ming-Chiang Li, “The Use of Interferoceiver for the Prevention of Fratricide in Missile Defense”, Proc. of SPIE 6968, 69681K, 1-12 (2008).

Higher precisions in Doppler velocities and micro Doppler signatures will lead to better avoidances of fratricide. However, there is a limiting factor on precision in the invented apparatus of application Ser. No. 11/231,841. It is the pulse length of signals.

As shown in embodiment 1120 of FIG. 11, tuning apparatus 102 takes signals from signal receiving apparatus 101 through signal path 1121, and inputs to stretching device 112. A front end apparatus selects, according to the requirement on the Doppler precision, stretching device 112 elongates signals from signal path 1121, and applies the elongated signals through signal path 1122 to replica generation apparatus 103.

Stretching device 112 can be RF or optical, and will be detailed later. The stretching reduces strengths of the elongated signals. If, necessary, the reduced strengths can be overcome by appropriate amplification, then it is understood that a signal amplifier might be inserted into either one of signal paths 1121 and 1122, or both of them to amplify the signals in signal path 1112. Many ways of fabricating amplifiers are known to those of ordinary skill in the art by following the present teaching. Thus, whenever the terms of amplifiers are used herein, they are meant to be used in their most general and inclusive sense.

As shown in embodiment 1130 of FIG. 11, tuning apparatus 102 takes signals from signal receiving apparatus 101 through signal path 1131, and inputs to stretching device 112. Stretching device 112 elongates the signals from signal path 1131, and applies the elongated signals through signal path 1132 to gating device 111. Gating device 111 selects a part of the signals from signal path 1132, and outputs the selected part through signal path 1142 to replica generation apparatus 103. A front end apparatus selects, according to the requirement of Doppler and spatial precisions, stretching device 112 and gating device 111.

As shown in embodiment 1150 of FIG. 11, tuning apparatus 102 takes signals from signal receiving apparatus 101 through signal path 1151, and inputs them to gating device 111. Gating device 111 selects a part of the signals from signal path 1151 and output the selected part through signal path 1152 to stretching device 112. Stretching device 112 elongates the signals from signal path 1152, and applies its outputs through signal path 1162 to replica generation apparatus 103. A front end apparatus selects, according to the requirement of spatial and Doppler precisions, gating device 111 and stretching device 112.

Tuning apparatus 102 can be complex, and comprises a number of gating devices and stretching devices. Embodiments 1110, 1120, 1130, and 1150 of FIG. 11 are just few of these examples to satisfy various requirements of ultra precision measurements. Those devices can take different forms or be integrated to form single devices. Many ways of fabricating tuning apparatus are known to those of ordinary skill in the art by following the present teaching. Thus, whenever the term of tuning apparatus is used herein, it is meant to be used in its most general and inclusive sense.

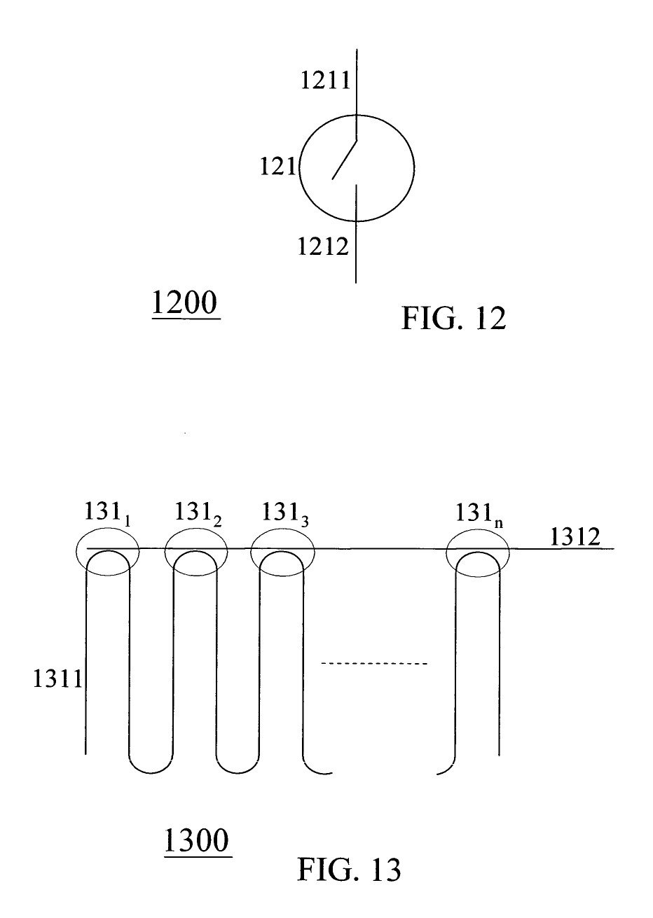

FIG. 12 shows, in pictorial form, embodiment 1200 of gating device 111, which selects a part of the signals from signal path 1211 through switch 121 in accordance with the requirement of spatial precision, for use in fabricating embodiments of the present invention. Switch 121 outputs the selected portion of signals to signal path 1212. As those of ordinary skill in the art would appreciate from FIG. 12, signals from optical path 1211 have been divided into two portions. The unwanted portion, which contains undesirable interferences and contaminations, has been discarded. The wanted portion of signals is output from optical path 1312. By discarding undesirable interferences and contaminations, the spatial precision increases. Many ways of fabricating switch are known to those of ordinary, skill in the art by following the present teaching. Thus whenever the term of switch is used herein, it is meant to be used in its most general and inclusive sense.

FIG. 13 shows, in pictorial form, embodiment 1300 of stretching device 112, which stretches input signals into elongated signals in accordance with the requirement of Doppler precision, for use in fabricating embodiments of the present invention. In particular, a stretching device changes the coherence of input signals, i.e., the coherence becomes higher for the output signals, which lead to higher Doppler precision. As shown in FIG. 13, signals are input to optical path 1331. Next optical path 1331 outputs the signals to optical path 1312 through a plurality of taps 131₁, 131₂ 131₃, . . . , 131ₙ. It is noted that the term of optical path is used in its most general sense. As those of ordinary skill in the art would appreciate from FIG. 13, signals from optical path 1311 are elongated when they are output from optical path 1312. The number of these taps may vary according to the requirement of elongation. Many ways of fabricating taps are known to those of ordinary skill in the art by following the present teaching. Thus whenever the terms of taps are used herein, they are meant to be used in their most general and inclusive senses.

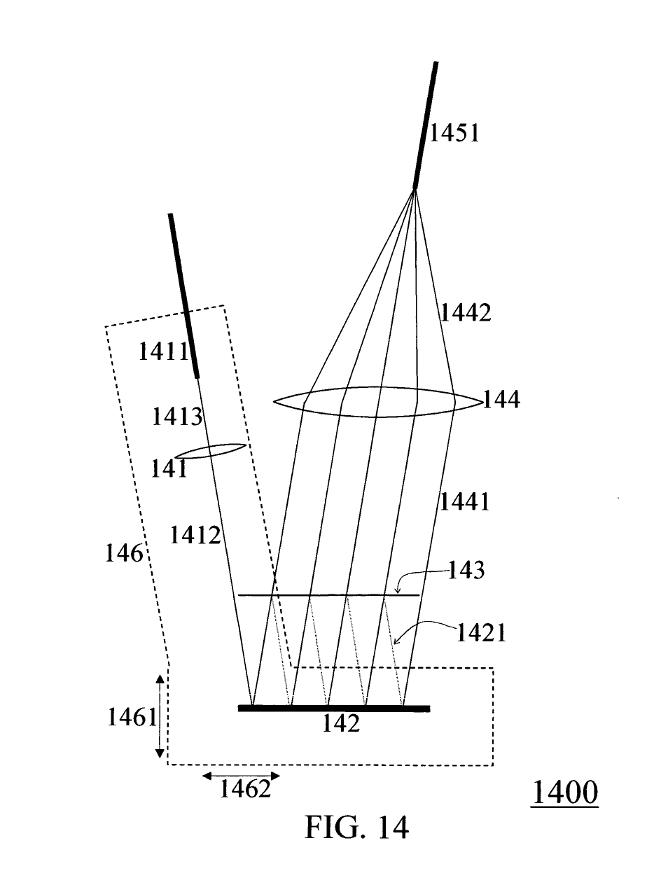

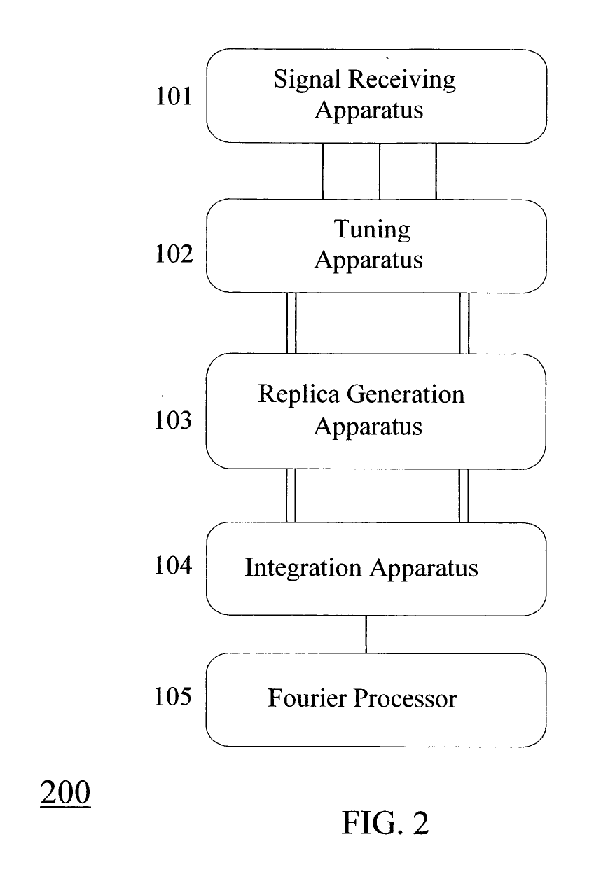

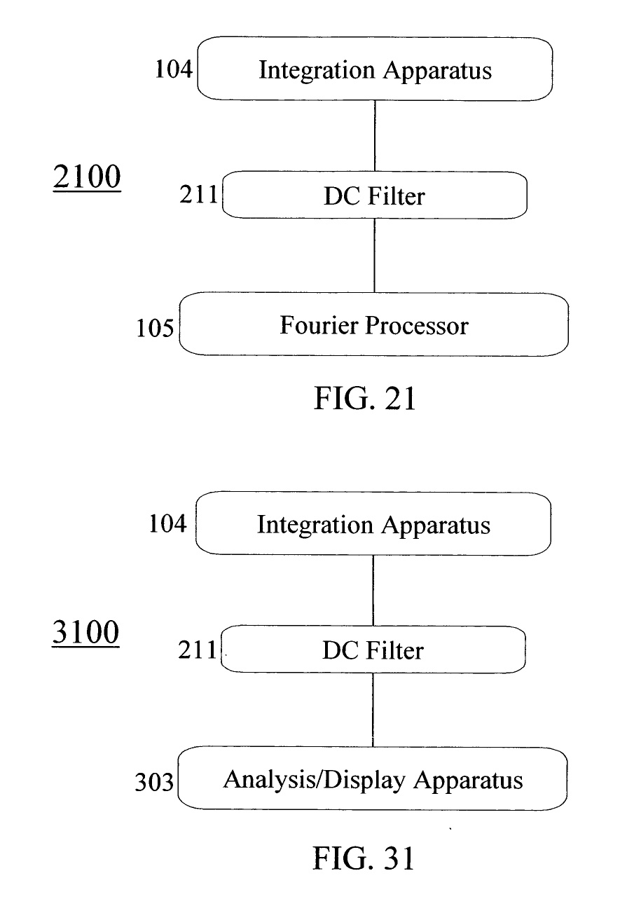

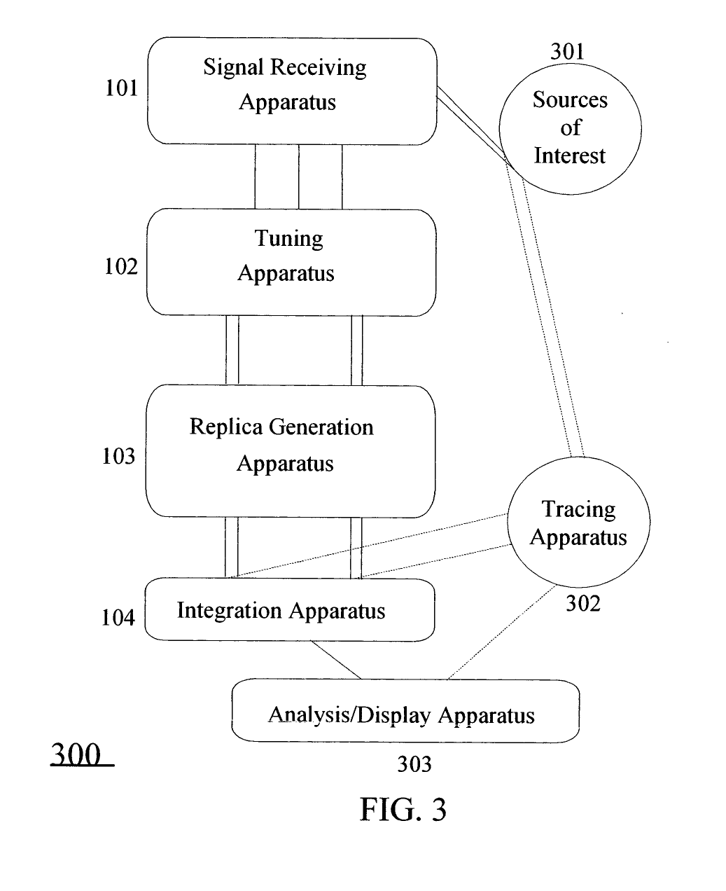

FIG. 14 shows, in pictorial form, embodiment 1400 of stretching device 112 which stretches input signals into elongated signals in accordance with the requirement of Doppler precision, for use in fabricating embodiments of the present invention. As shown in FIG. 14, optical beam 1413 is output from optical path 1411 at the back focal plane of lens system 141. Beam 1412 is output from lens system 141 and is comprised of a parallel rays. Next beam 1412 is applied as input to mirror 142, and is reflected back and forth between mirror 142 and half silvered mirror 143. These two mirrors are parallel to each other. A silvered mirror only reflects a portion of beam and transmits the remaining portion. The multiple reflections between mirror 142 and half silvered mirror 143 lead to a plurality of parallel reflected beams 1421 and transmitted beams 1441. Next transmitted beams 1441 are applied as input to lens systems 144, and focused beams 1442 which are output by lens system 144 are input to optical path 1451 at the back focal plane of lens system 144. As shown in FIG. 11, signals from optical path 1411 through beam 1413, lens system 141, beam 1412, reflecting mirror 142, reflected beams 1421, transmitting half silvered mirror 143, transmitted beams 1441, and lens system 144 enter to optical path 1451. It is noted that the term of optical path is used in its most general sense. As those of ordinary skill in the art would appreciate from FIG. 14, signals from optical path 1411 are elongated when they are output from optical path 1451.

In a further embodiment of stretching device 112 for use fabricating embodiments of the present invention, stretching device 112 includes launching assembly 146 (shown pictorially by dotted box) that is movable in directions indicated by double arrows 1461 and 1462. The movements of launching assembly 146 provide a common, continuous variable in elongating signals from optical path 1411. Many methods and apparatus (not shown) for moving assembly 146 are known to those of ordinary skill in the art. Thus, whenever the term of launching assembly is used herein, it is meant to be used in its most general and inclusive sense.

The present application is for ultra precision measurements of transient signals. n order to capture the precise intrinsic information or spatial distribution of micro Doppler signature contained in a transient signal, signal receiving apparatus 101 has to divide or separate the transient signal into a plurality of branches for processing simultaneously by the apparatus of the present invention with a plurality of stretching devices and/or gating devices, and delay adjustment apparatus. Signal dividers divide and signal separators separate the transient signal. Delay adjustment apparatus, signal dividers, and signal separators are shown in the patent application “Robust and Broadband Signal Processing using. Replica Generation Apparatus”, application Ser. No. 11/231,841. The specification of the above application, as was mentioned above, is incorporated by reference herein. A simultaneous process leads to detailed intrinsic signatures of transient signals, for instance the spatial distributions of micro Doppler. Thus, whenever the terms of delay adjustment apparatus, signal divider, and signal separator are used herein, they are meant to be used in their most general and inclusive senses.

FIG. 3 shows, in pictorial forms, another embodiment 300 of apparatus 100, which further comprises analysis/display apparatus 303, sources of interest 301, and tracing apparatus 302. Sources of interest 301 are shown in the patent application “Robust and Broadband Signal Processing using Replica Generation Apparatus”, application Ser. No. 11/231,841. These sources can be acoustical, electromagnetic, mechanical, infrared, optical, or nuclear. The specification of the above application, as was mentioned above, is incorporated by reference herein. Thus, whenever the terms of sources of interest are used herein, they are meant to be used in their most general and inclusive sense.

Tracing apparatus 302 traces signals to be measured on their respective times emitted from sources of interest 301 and on their respective lengths of signal paths from sources of interest 301 through signal receiving apparatus 101, tuning apparatus 102, and replica generation apparatus 103, to integration apparatus 104. Finally as shown in FIG. 3, the outputs from integration apparatus 104 and tracing apparatus 302 are transmitted to analysis/display apparatus 303.

Analysis/display apparatus 303 have the ability, in accordance with methods that are known to those of ordinary skill in the art, to accept input information, either from apparatus such as computers or directly from an operator to direct, for example, the activities of apparatus 100 and tracing apparatus 302 in the sense of selecting sources of interest 301. Thus, whenever the term analysis/display apparatus is used herein, it is meant to be used in its most general and inclusive sense.

The theory of accurate range determination is documented in the published paper, “The Use of Optical RF Network for Target Detection and Tracking”, Proc. SPIE 6567, 656711, 1-11 (2007). Theory is also presented in the published paper, “The Use of Interferoceiver for the Prevention of Fratricide in Missile Defense”, Proc. of SPIE 6968, 69681K, 1-12 (2008). These papers are incorporated by reference herein. As described in the papers, the range is determined through the maximum of correlation between the transmitted and reflected radar pulses according to the information from integration apparatus 104 and tracing apparatus 302. Analysis/display apparatus 303 analyzes the above information and displays findings of interest.

Applications discussed in above two papers are just examples. Based on the teaching of the present invention, those of ordinary skill in the art would appreciate that apparatus 300 has many different applications. Thus, it is not intended to be exhaustive or to limit the invention to precise applications as disclosed in these two papers.

FIG. 21 and FIG. 31 show, in pictorial form, embodiments 2100 and 3100 of DC filters, which remove the direct current from outputs of integration apparatus 104 for use in fabricating embodiments of the present invention. The DC current is independent on the recirculation number. It is resulted from noises and background contributions. Depending on the design of integration apparatus 104, its outputs might contain a large direct current (DC). If this is the case, then it is optimum to remove the large direct current by inserting a DC filter between integration apparatus 104 and Fourier processor 105 as in FIG. 21, or between integration apparatus 104 and analysis/display apparatus as in FIG. 22. The DC filter is known to those of ordinary skill in the art by following the present teaching. Thus, whenever the term DC filter is used herein, it is meant to be used in its most general and inclusive sense.

A signal source is three dimensional. Its location and velocity are vectors. To capture its intrinsic features, its signals have to be received at a plurality of angles (sites) simultaneously as shown in the patent application “Robust and Broadband Signal Processing using Replica Generation Apparatus”, application Ser. No. 11/231,841. The specification of the above application, as was mentioned above, is incorporated by reference herein. Thus, whenever the term of receiving is used herein, it is meant to be used in its most general and inclusive sense.

In accordance with the present invention, replicas in pairs have to be overlapped in correlation operations. An alignment is needed to achieve overlaps as shown in the patent application “Robust and Broadband Signal Processing using Replica Generation Apparatus”, application Ser. No. 11/231,841. The specification of the above application, as was mentioned before, is incorporated by reference herein. More overlapping in Doppler correlations will lead to better Doppler accuracy. It should be understood that a best alignment should be made to achieve the maximum overlapping. Replica overlapping changes with the recirculation number of replica pairs in self or mutual correlations. Higher recirculation number of replica pair overlaps will lead to better spatial or frequency precisions. It should also be understood that the best alignment should be made to achieve the highest recirculation number of replica pair overlaps. Many ways to achieve the best alignments are known to those of ordinary skill in the art by following the present teaching. Thus, whenever the term of alignment is used herein, it is meant to be used in its most general and inclusive sense.

As those of ordinary skill in the art would appreciate, by following the teaching of “Robust and Broadband Signal Processing using Replica Generation Apparatus”, application Ser. No. 11/231,841, the pulse length of a receiving signal directly limits the spatial and Doppler precisions. The present teaching takes away the limit to overcome the identified problems as mentioned above and to achieve ultra high precisions in response to requirements.

Those skilled in the art will recognize that the foregoing description has been presented for the sake of illustration and description only. As such, it is not intended to be exhaustive or to limit the invention to the precise form disclosed.

What is claimed is:

1. An apparatus for processing transient signals which comprises:
a signal receiving apparatus, which receives one or more signals;
a tuning apparatus which accepts signals from the signal receiving apparatus as inputs, tunes one or more of these signals in response to a requirement of interest, where the requirement of interest includes, but not limited to, shortening or elongating one or more pulse lengths of these signals;
a replica generation apparatus, which accepts signals from the tuning apparatus as inputs, and outputs a train of replica pairs, where relative separations between two members in the replica pairs are same or different; and
an integration apparatus which performs correlation integrations that are to correlate the two members in the replica pairs, and to convert the train of replica pairs into a baseband signal, and outputs the baseband signal.

2. The apparatus of claim 1 wherein the tuning apparatus comprises a gating device responsive to specific spatial precisions.

3. The apparatus of claim 2 wherein the gating device comprises an on-and-off switch.

4. The apparatus of claim 1 wherein the tuning apparatus comprises a stretching device responsive to specific Doppler precisions.

5. The apparatus of claim 4 wherein the stretching device comprises an optical path with a plurality of taps.

6. The apparatus of claim 5 wherein the taps are adjustable in response to the requirement of interest.

7. The apparatus of claim 4 wherein the stretching device comprises a lens to output parallel rays, two parallel mirrors to reflect the parallel rays, and a lens to focus the reflected parallel rays, wherein one of the mirrors is regular and the other is a half silvered.

8. The apparatus of claim 7 wherein the lens to output parallel rays and the regular mirror form an assembly, wherein the assembly is movable in response to the requirement of interest.

9. The apparatus of claim 1 which further comprises:
a tracing apparatus which traces path lengths of signal paths from signal sources of interest through the signal receiving apparatus, tuning apparatus, and replica generation apparatus to the integration apparatus, evaluates and outputs path length differences of two members in the replica pairs; and
an analysis/display apparatus which accepts inputs from the integration apparatus and tracing apparatus, and analyzes the inputs.

10. The apparatus of claim 9 wherein the tracing apparatus further traces signal emission times from the signal sources of interest and outputs the signal emission times to the analysis/display apparatus.

11. The apparatus of claim 1 which further comprises a DC filter to remove a direct current component in the baseband signal from the integration apparatus.

12. The apparatus of claim 1 which further comprises a Fourier processor analyzing the base band signal from the integration apparatus with or without the DC current component.

13. An apparatus for processing transient signals which comprises:
a signal receiving apparatus, which receives one or more signals;
one or more tuning apparatus which accept signals from the signal receiving apparatus as inputs, tune one or more of these signals in response to a requirement of interest, where the requirement of interest includes, but not limited to, shortening or to elongating one or more pulse lengths of these signals;
one or more replica generation apparatus, which accept signals from the tuning apparatus as inputs, and outputs one or more trains of replica pairs, where relative separations between two members in the replica pairs are same or different;
one or more integration apparatus which perform correlation integrations that are to correlate two members in the replica pairs and to convert the trains of replica pairs into baseband signals; and
one or more Fourier processors to analyze outputs from integration apparatus.

14. The apparatus of claim 13 wherein the signal receiving apparatus further comprises one or more signal dividers (separators) to split the one or more signals and outputs split signals to tuning apparatus so that members in replica pairs from these split signals are correlated by the integration apparatus simultaneously.

15. The apparatus of claim 14 which further comprises a tracing apparatus which traces path lengths of signal paths from signal sources of interest through the signal receiving apparatus, tuning apparatus, and replica generation apparatus to the integration apparatus, and evaluates path length differences between two members in the replica pairs. Furthermore the tracing apparatus traces source emission times from the signal sources of interest, and outputs the emission times and path length differences to analysis/display apparatus.

16. The apparatus of claim 15 wherein the analysis/display apparatus takes inputs from the integration apparatus and the tracing apparatus, and outputs intrinsic features of the received signals by the signal receiving apparatus.

17. A method of processing intrinsic signals which comprises the steps of:
receiving one or more signals;
applying the received signals to a tuning apparatus;
tuning the received signals, but not limited to, by shortening or elongating one or more pulse lengths of these signals;
outputting signals from the tuning apparatus to a replica generation apparatus;
outputting a train of replica pairs from the replica generation apparatus to an integration apparatus;
performing correlation integrations on the replica pairs at RF or optical level.

18. The method of claim 17 wherein the tuning method comprises the steps of:
gating for shortening one or more pulse lengths of the received signal; or
tapping through a tapped optical path for elongating the pulse lengths; or
reflecting through lenses and parallel mirrors for elongating the pulse lengths.

19. The method of claim 17 which further comprises the steps of:
tracing signal path lengths of the received signals from sources of interest down to the integration apparatus, and signal emission times from the sources of interest;
evaluating differences of the signal path lengths and of the emission times between two members of replica pairs;
analyzing the correlation integrations based on the differences.

20. The method of claim 17 which comprises the step of:
Fourier analyzing the correlation integrations.
